(19) United States
(12) Patent Application Publication
(10) Pub. No.: US 2024/0193553 A1
(43) Pub. Date: Jun. 13, 2024

(54) DEVICE AND METHOD FOR SUPPORTING MAINTENANCE WORK

(71) Applicant: Hitachi, Ltd., Chiyoda-ku, Tokyo (JP)

(72) Inventors: Yutaro NAKAMURA, Tokyo (JP); Yuki KOBAYASHI, Tokyo (JP); Yuji KIMURA, Tokyo (JP)

(21) Appl. No.: 18/285,756

(22) PCT Filed: Jul. 20, 2021
(86) PCT No.: PCT/JP2021/027071

§ 371 Date: Oct. 5, 2023

(51) Int. Cl. G06Q 10/20; G06Q 10/0639

(52) U.S. Cl. CPC G06Q 10/20; G06Q 10/06393

(57) ABSTRACT

For a maintenance work, an object is to enable creation of a work plan that reflects a long-term perspective and a perspective according to management indexes of a client company. For example, the perspectives include ensuring future veteran on-site workers by spending money on education. The perspectives also include achieving medium- to long-term cost reductions by reducing the number of revisits due to work mistakes and reducing a standard work time. In the invention, an AI 1 is used to create a maintenance work plan based on work history information 2 and site information 3, and present the created maintenance work plan to each person concerned. At this time, the AI 1 uses company goal information (company KPI information 4) of the maintenance company to evaluate and screen the created maintenance work plan.

### TECHNICAL FIELD

The present invention relates to technology for supporting maintenance work for equipment. In addition, the equipment includes various devices such as instruments, machines (IT resources), facilities, products, and so on. In addition, maintenance includes various works such as repair, replacement, inspection (maintenance), and so on.

### BACKGROUND ART

Currently, for equipment that is in operation, an on-site worker goes to the site to perform maintenance work on the equipment. Here, for example, the maintenance work may be entrusted by an owner of the equipment to an on-site worker of a company which is a seller of the equipment and performed by the on-site worker instead of the owner. Therefore, the on-site workers are required to perform efficient maintenance work to meet the demands of their contractors, i.e., the owners who are their clients (hereinafter referred to as “client companies”). As a technology to implement this, maintenance recommendations have been proposed to improve the efficiency of on-site worker arrangements. For example, PTL 1 adopts a configuration described below for increasing the satisfaction of users of an application that makes recommendations.

A repair recommendation system of PTL 1 includes an input unit to which input information about an event is input, a recommendation calculation unit that, using a learning model having the input information about the event as an input and a recommended repair to deal with the event as an output, infers recommendation information including a plurality of recommended repairs for the input information about the event that is input and a certainty level that indicates the accuracy of each repair, a keyword calculation unit that selects a keyword related to each repair included in the recommendation information from a keyword list in which keywords related to the repair are registered, and an output unit that outputs the recommendation information and the keyword related to each repair together.

### CITATION LIST

### Patent Literature

PTL 1: JP2021-022205A

### SUMMARY OF INVENTION

### Technical Problem

Here, as described in PTL 1, machine learning and artificial intelligence (AI) have been used for the efficiency of maintenance work. These existing machine learning methods can return the best answer to an input event according to predetermined rules and criteria. In the client company as the owner of the equipment who leads the maintenance work, management indexes of the client company, which are to be emphasized for the enhancement of the efficiency of maintenance, are set in advance, and AI makes recommendations related to maintenance on the premise of contributing to these management indexes. The management indexes of the client company include management indexes of the client company itself, and management indexes of a maintenance company that considers the management goals of the client company. In addition, the management indexes include Key Performance Indicators (KPIs) and Key Goal Indicators (KGIs). In addition, possessing the equipment also includes possessing by renting the equipment. Therefore, the client company may be any company that uses and manages the equipment.

Meanwhile, among the KPIs, which are examples of the management indexes of the client company, certain KPIs, which are to be emphasized, change from moment to moment depending on the company's management conditions. For this reason, it is difficult to make recommendations for improving the certain KPIs that change at each time and which are to be emphasized, among the KPIs, with the AI-based recommendations that are based on the predetermined rules and criteria as in the case of related technology. Furthermore, since the KPIs are highly correlated with each other, placing an emphasis on one KPI always results in a trade-off relationship that deteriorates the other KPIs, and this makes it even more difficult to select the important KPIs that best suit the management situation at that time and which are to be emphasized, after overviewing all KPIs.

In other words, in the related art, the problem is that the AI's answers based on predetermined client KPIs as described above are not necessarily the best solutions at each time when reflecting the perspective according to the management indexes of the company, especially the client company, and flexible recommendations are not made that take into consideration the KPIs, which are to be most emphasized, of the client company at each time in maintenance work, and the impact of a plurality of correlated KPI groups on overall business activities.

### Solution to Problem

In order to solve the problems described above, according to the invention, a created maintenance work plan is evaluated using company goal information (company KPI information) of the maintenance company, which is the company goal information of the client company. More specifically, according to a configuration of the invention, a device for supporting maintenance work that supports a maintenance work of equipment includes: an integrated database that stores work history information relating to the maintenance work of the equipment and company KPI information including a company KPI which is an item emphasized by an owner of the equipment; a maintenance work plan creation unit that creates a maintenance work plan showing a plan for the maintenance work of the equipment using the work history information; and an evaluation unit that calculates, for the created maintenance work plan using the company KPI information, an evaluation according to a company KPI corresponding to a plurality of variables indicating maintenance work conditions for the equipment.

The invention also includes a method for supporting maintenance work using the device for supporting maintenance work, a program for causing a device for supporting maintenance work to function as a computer, and a storage medium storing this program.

### Advantageous Effects of Invention

According to the invention, it is possible to create a work plan that reflects a long-term perspective and a perspective according to the management indexes of the client company. This makes it possible to create a value for the work of the client company.

### BRIEF DESCRIPTION OF DRAWINGS

FIG. 1 is a conceptual view showing a concept of an embodiment of the invention.

FIG. 2 is a view showing an overview of a process in the embodiment of the invention.

FIG. 3 is a configuration view of a system for executing the process in the embodiment of the invention.

FIG. 4 is a hardware configuration view of a device for supporting a maintenance work that includes an integrated database in the embodiment of the invention.

FIG. 5 is a view showing a variable correspondence table used in the embodiment of the invention.

FIG. 6 is a view showing work history information used in the embodiment of the invention.

FIG. 7 is a view showing site information used in the embodiment of the invention.

FIG. 8 is a view showing company KPI information used in the embodiment of the invention.

FIG. 9 is a view showing a maintenance work plan created in the embodiment of the invention.

FIG. 10 is a flowchart showing a content of a process of the device for supporting a maintenance work in the embodiment of the invention.

FIG. 11 is a view showing an example of presentation contents of evaluation results in the embodiment of the invention.

FIG. 12 is a view showing correlation information used in the embodiment of the invention.

FIG. 13 is a view showing registered company KPI information used in a second embodiment of the invention.

### DESCRIPTION OF EMBODIMENTS

### First Embodiment

Hereinafter, a first embodiment of the invention will be described with reference to the drawings. In the present embodiment, it is assumed that a maintenance company performs a maintenance work. However, the maintenance work can also be performed by a client company. In this case, the maintenance work performed by the client company can be implemented by replacing the maintenance company with the client company in the following description. Furthermore, the client company is only required to use and manage the equipment and does not necessarily have to be a client. Moreover, the client company, the maintenance company, a system vendor, and a service provider in the present embodiment are not limited to companies, and include various groups and organizations.

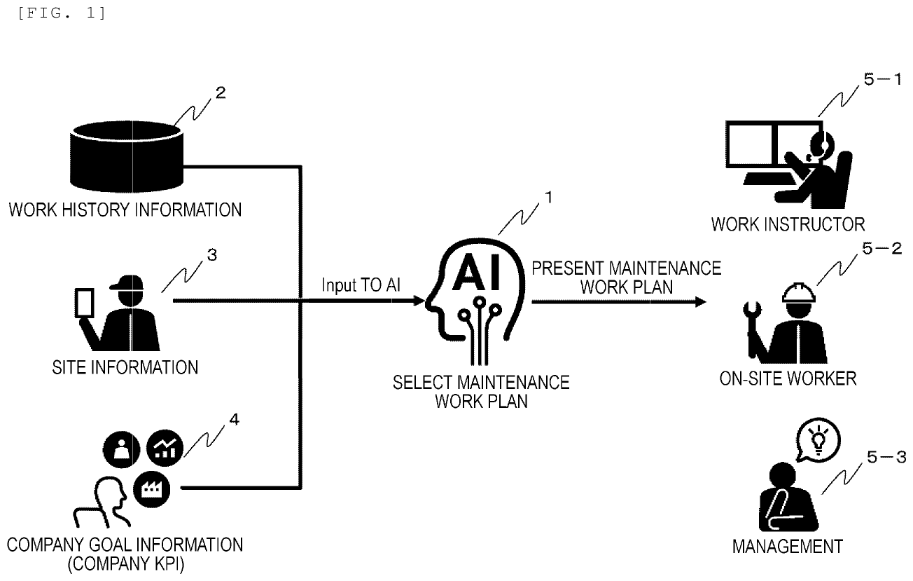

FIG. 1 is a conceptual view showing the concept of the present embodiment and a second embodiment (hereinafter simply referred to as the present embodiment) to be described below. In the present embodiment, an AI 1 is used to support the maintenance work. For this purpose, first, work history information 2, site information 3, and company KPI information 4 which is KPI information indicating a goal of the maintenance company are input to the AI 1. Here, the work history information 2 includes maintenance history, difficulty of maintenance, number of use of parts, work skill, and the like in maintenance. In addition, the site information 3 includes information obtained at a maintenance site, such as failure status, product operation history, and so on. Furthermore, the company KPI information 4 is information that serves as goals or indicators for the maintenance company, such as cost reduction, educational goals, and so on.

Then, using the input information, the AI 1 creates and selects a maintenance work plan through machine learning, optimization algorithms, and the like. Next, the AI 1 presents the maintenance work plan to each person concerned in the maintenance company. The persons concerned include a work instructor 5-1, an on-site worker 5-2, and a management 5-3 such as managers.

Here, the company KPI information 4 is KPI information that indicates the goal of the maintenance company, and this is KPI information about the client company that is an owner of the equipment in need of maintenance. In other words, the company KPI information 4 is KPI information that considers the management goals and KGIs of the client company. In particular, the company KPI information 4 is preferably information for achieving the management goals and the KGIs. In addition, when the client company itself performs the maintenance work, the KPI information of the client company is used as the company KPI information 4. In this way, the company KPI information 4 is information that makes it possible to create a value for the maintenance work of the client company.

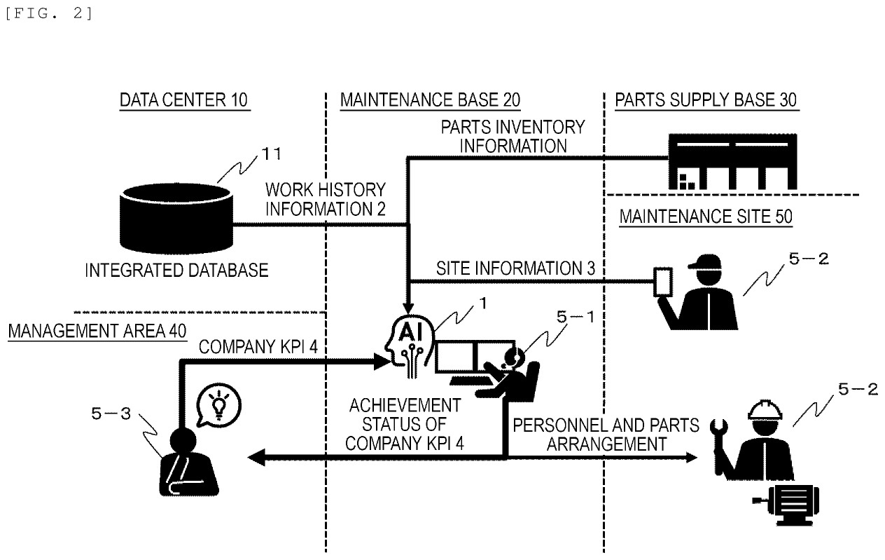

Next, FIG. 2 shows an overview of a process in the present embodiment. In the present embodiment, the process is executed in association with a plurality of bases and locations. The plurality of bases and locations include a data center 10, a maintenance base 20, a parts base 30, a management area 40, and a maintenance site 50.

The data center 10 is provided with an integrated database 11 that stores various kinds of data such as the work history information 2, the site information 3, and the company KPI information 4. In addition, at the maintenance base 20, the work instructor 5-1 uses the AI 1 to create the maintenance work plan described above. For this reason, the maintenance base 20 is assumed to be an office of the maintenance company or the like. It is to be noted that the maintenance base 20 may be in an environment in which the AI 1 can be used, and may be installed at another location. For example, it is assumed that the other location is the data center 10.

The parts base 30 is a warehouse or the like that stores parts used for the maintenance work, and manages parts inventory information. The management area 40 can be implemented in an office or the like where the management 5-3 is stationed. Then, the equipment in need of maintenance is installed at the maintenance site 50, and the on-site worker 5-2 is dispatched to the maintenance site 50.

Here, the process in FIG. 2 will be described. In this process, creating and selecting the maintenance work plan are mainly performed using the AI 1 described in FIG. 1. For this purpose, the AI 1 receives the work history information 2 from the integrated database 11. In addition, the AI 1 also receives the company KPI information 4 from the management 5-3. Furthermore, the AI 1 receives the parts inventory information at the parts base 30. In addition, the AI 1 receives the site information 3 from the maintenance site 50.

Then, the AI 1 uses the received information to create and select the maintenance work plan. At this time, it is desirable for the AI 1 to process according to an operation of the work instructor 5-1. In addition, the AI 1 presents, as the maintenance work plan, arrangement of personnel and parts for the maintenance work to the maintenance site and the work instructor 5-1. In addition, the AI 1 calculates evaluations on the maintenance work plan, such as achievement status of the company KPI information 4, and presents the evaluations to the work instructor 5-1 and the management 5-3.

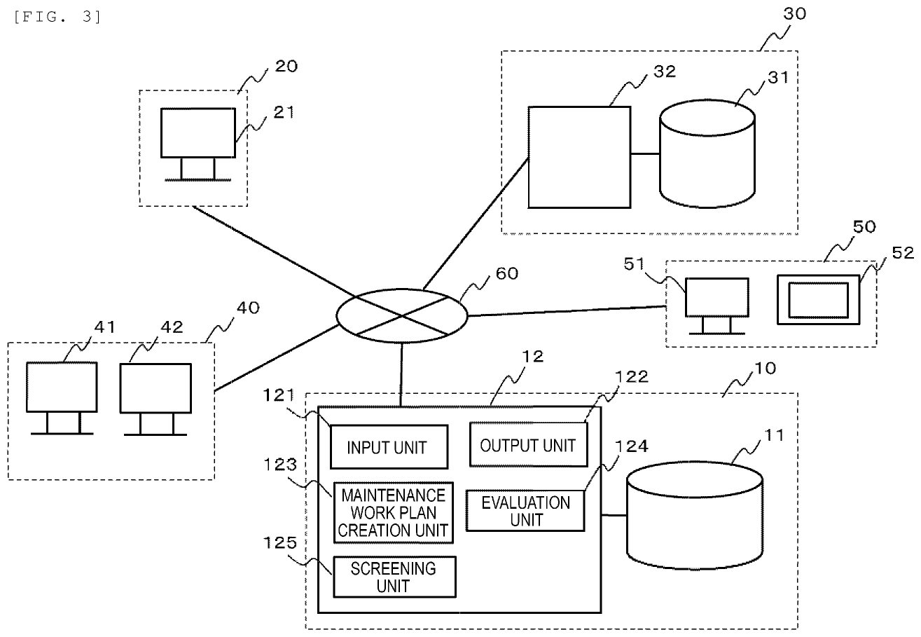

This concludes the description of the overview of the process in the present embodiment. Next, the details of the present embodiment will be described. FIG. 3 is a configuration view of a system for executing the process in the present embodiment.

In the present embodiment, an information processing device, which will be described below, is provided in each of the data center 10, the maintenance base 20, the parts base 30, the management area 40, and the maintenance site 50 shown in FIG. 2. First, the data center 10 is provided with the integrated database 11 and a device 12 for supporting maintenance work. In addition, the maintenance base 20 is provided with an instructor device 21 operated by the work instructor 5-1. Although only one instructor device 21 is shown in FIG. 3, a plurality of devices may be provided.

In addition, the parts base 30 is provided with a parts inventory database 31 and a parts inventory management device 32, which enable the parts inventory information. In addition, the management area 40 is provided with management devices 41 and 42 used by the management 5-3. While FIG. 3 shows two management devices, the devices are not limited to this number. In addition, a worker terminal 51 or a worker tablet 52 used by the on-site worker 5-2 is used at the maintenance site 50. These can be implemented by notebook PCs and smartphones.

Each of these devices is connected to each other via a network 60. In addition, each device can be implemented by a so-called computer. It is to be noted that the network 60 may be connected to systems and PCs of the client company. With this configuration, the management indexes and management goals of the client company itself can be acquired by the device 12 for supporting maintenance work and other devices. With this, the device 12 for supporting maintenance work can specify the company KPI information 4 about the client company. In addition, each device may acquire the management indexes and the management goals of the client company itself offline.

In addition, the data center 10 is preferably operated by a system vendor who builds the integrated database 11 and the device 12 for supporting maintenance work, or by a service provider who provides recommendations for the maintenance work. Alternatively, this may be operated by the maintenance company.

Next, the details of each device are described. First, the integrated database 11 can be implemented by a so-called file server. In addition, the integrated database 11 may be implemented as a storage device provided in the device 12 for supporting maintenance work.

Next, the device 12 for supporting maintenance work executes a main process in the present embodiment and can be implemented by a so-called server. In addition, the function of the AI 1 is installed. In this way, the present embodiment can be built as a cloud system. Here, the configuration of the device 12 for supporting maintenance work will be described as a functional block. The device 12 for supporting maintenance work has an input unit 121, an output unit 122, a maintenance work plan creation unit 123, an evaluation unit 124, and a screening unit 125. The input unit 121 receives information and the like from other devices via the network 60. The output unit 122 outputs information and the like to other devices via the network 60.

In addition, the maintenance work plan creation unit 123 creates the maintenance work plan described above. In addition, the evaluation unit 124 calculates an evaluation for the maintenance work plan. Furthermore, the screening unit 125 selects and screens the maintenance work plan to be proposed based on the calculated evaluation. In this way, the device 12 for supporting maintenance work executes the process of the AI 1 described above. Details of the process of each unit will be described below using a flowchart.

Next, the instructor device 21 causes the device 12 for supporting maintenance work to execute each process according to the operation of the work instructor 5-1. In addition, the instructor device 21 displays the processing result of the device 12 for supporting maintenance work. For this purpose, the instructor device 21 can be implemented by a PC.

Next, the parts inventory database 31 stores the parts inventory information and can be implemented by a so-called file server. The parts inventory database 31 may be implemented as a storage device provided in the parts inventory management device 32. The parts inventory management device 32 can be implemented by a so-called server, and uses the parts inventory information to execute information processing for managing the parts in the parts base 30.

Next, the management devices 41 and 42 receive the company KPI information 4 from the management 5-3 as an input, and output the achievement status of the company KPI information 4 from the device 12 for supporting maintenance work. For this reason, the management devices 41 and 42 can be implemented by PCs. Next, the worker terminal 51 or the worker tablet 52 outputs site information 3 to the device 12 for supporting maintenance work or outputs the maintenance work plan.

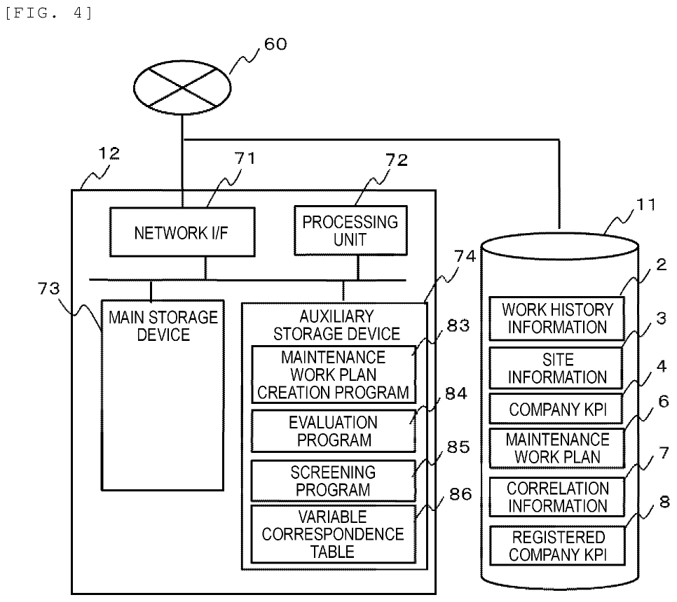

Next, the hardware configuration of the device 12 for supporting maintenance work that executes the main process in the present embodiment will be described with reference to FIG. 4. FIG. 4 also shows the integrated database 11, and details of the integrated database 11 will also be described below.

The device 12 for supporting maintenance work has a network I/F 71 (network interface), a processing unit 72, a main storage device 73, and an auxiliary storage device 74, which are connected to each other via a communication path such as a bus. Here, the network I/F 71 is connected to the network 60 and corresponds to the input unit 121 and the output unit 122 in FIG. 3.

Next, the processing unit 72 is implemented by a processor such as a CPU, and executes processing according to programs described below. The main storage device 73 is implemented by a Random Access Memory (RAM) or the like, and programs are loaded according to processing of the processing unit 72. Further, the auxiliary storage device 74 is implemented by a storage such as a Read Only Memory (ROM), a Hard Disk Drive (HDD), and a Solid State Drive (SSD).

The auxiliary storage device 74 stores a maintenance work plan creation program 83, an evaluation program 84, and a screening program 85. These programs may be distributed to the device 12 for supporting maintenance work via the network 60 or other storage media.

The auxiliary storage device 74 also stores a variable correspondence table 86 used for the evaluation program 84 and an evaluation process of the evaluation unit 124. The variable correspondence table 86, as shown in FIG. 5, is a table indicating the correspondence relationship between a plurality of variables that indicate maintenance work conditions for equipment and the company KPIs which are items emphasized by the maintenance company. The details, along with the evaluation process, will be described using a flowchart.

The units shown in FIG. 3 that execute the same process as each program are as follows.
Maintenance work plan creation unit 123: maintenance work plan creation program 83
Evaluation unit 124: evaluation program 84
Screening unit 125: screening program 85

In addition, the auxiliary storage device 74 may store various kinds of information stored in the integrated database 11.

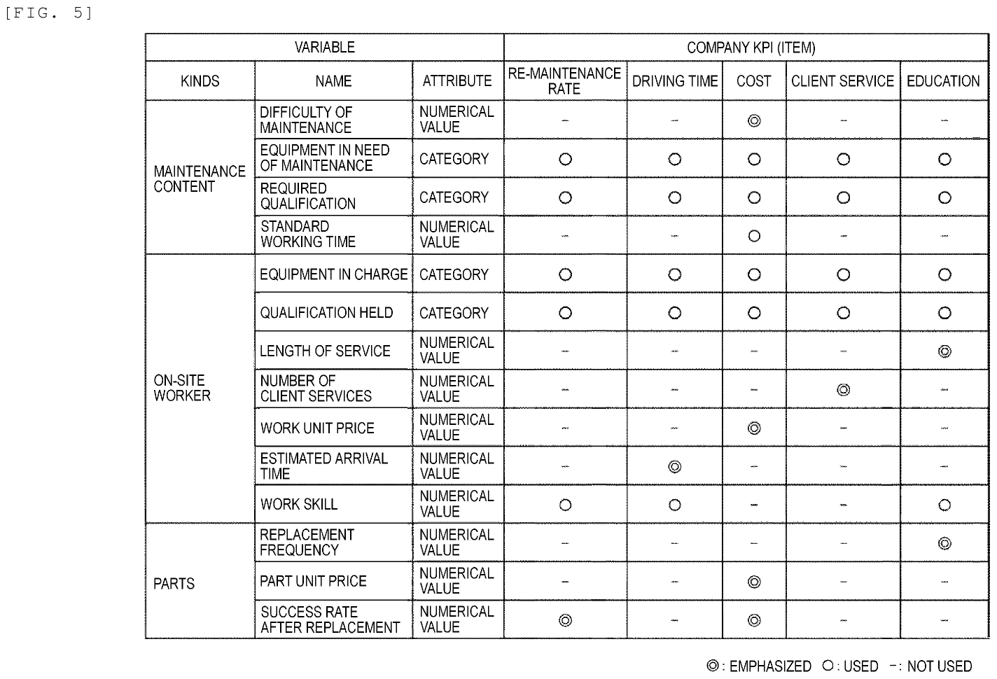

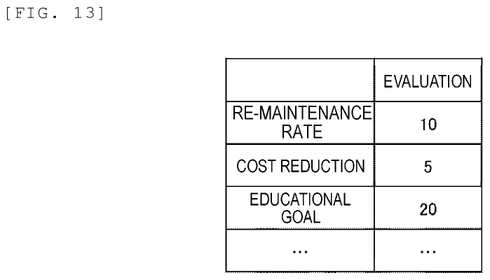

Next, in the integrated database 11 in FIG. 4, the work history information 2, the site information 3, the company KPI information 4, a maintenance work plan 6, correlation information 7, and a registered company KPI 8 are stored. However, each of these pieces of information, in particular, the site information 3, the company KPI information 4, the maintenance work plan 6, the correlation information 7, and the registered company KPI 8 may be stored in other devices rather than being stored in the integrated database 11. The work history information 2, the site information 3, the company KPI information 4, and the maintenance work plan 6 of these pieces of information mentioned above will be described with reference to FIGS. 6 to 9. The correlation information 7 will be described below with reference to FIG. 12. In addition, since the registered company KPI 8 is used in a second embodiment, the registered company KPI 8 will be described in the second embodiment to be described below.

First, FIG. 6 shows the work history information 2 used in the present embodiment. In the present embodiment, the work history information 2 is managed as information for (a) content of maintenance, (b) on-site workers, and (c) parts, for example, but may be managed in other forms. While the information shown in (a) to (c) is often emphasized as the company KPI in the maintenance work, because the information includes variables that have a trade-off relationship with each other, by using these pieces of information, it is possible to make recommendations according to the management indexes of the client company.

The (a) content of maintenance, (b) on-site workers, and (c) parts correspond to the types of variables in the variable correspondence table 86 in FIG. 5. Each of (a) to (c) of the work history information 2 will be described below. (a) is information corresponding to the content of maintenance of the work history information 2, and information on the content of maintenance work such as maintenance history and operation difficulty is associated with each piece of equipment in need of maintenance. (b) is information corresponding to the on-site worker of the work history information 2, and information on skill such as work skill and the corresponding product is associated with each on-site worker. (c) is information on parts of the work history information 2, and information indicating the characteristics of the part is associated with each part. In the present embodiment, each part is associated with each piece of installed equipment, but other modes are possible. For example, the equipment may be omitted.

Although not shown in FIG. 6, it is preferable that each item of the work history information 2 (maintenance history, work skill, part unit price, and the like) is prepared to correspond to the variable (name) in the variable correspondence table 86.

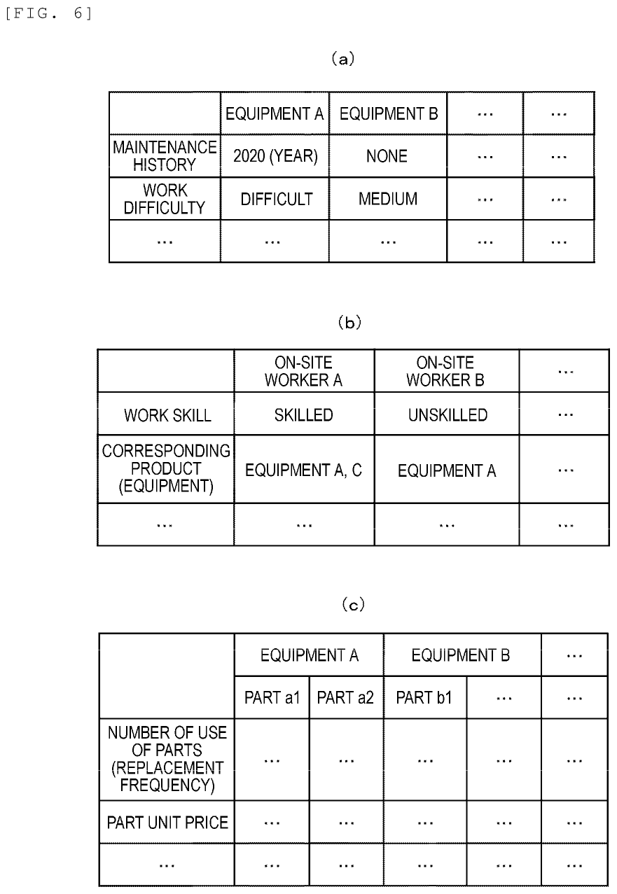

Next, FIG. 7 shows the site information 3 used in the present embodiment. In the site information 3 in the present embodiment, maintenance-related information input from the worker terminal 51 or the worker tablet 52 at the corresponding maintenance site 50 is associated with each piece of equipment. The site information 3 includes status of the corresponding equipment or parts, the corresponding parts, operation history of the corresponding equipment or parts, content of maintenance work, and the on-site worker who performs a work.

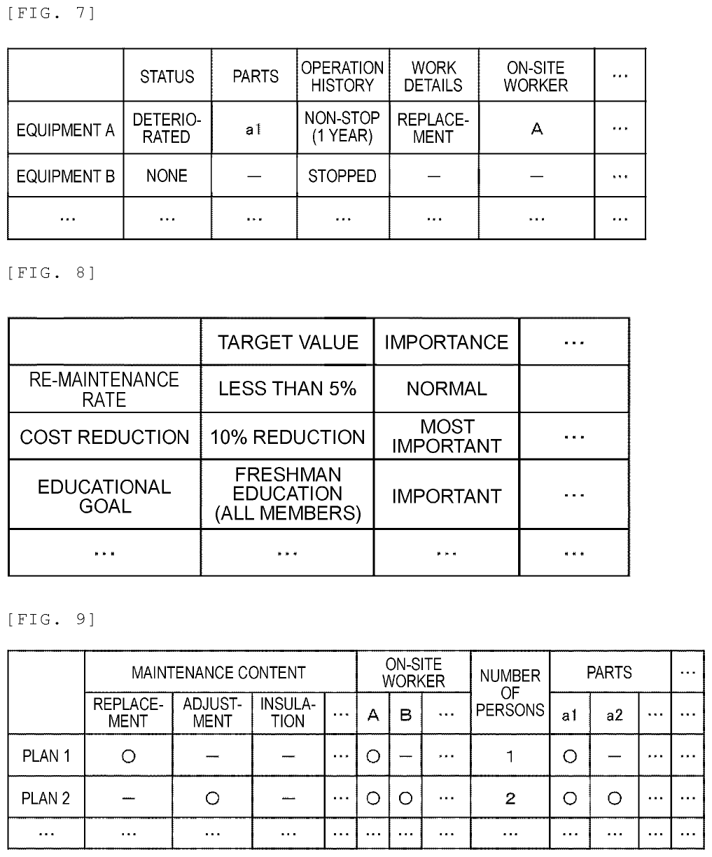

Next, FIG. 8 shows the company KPI information 4 used in the present embodiment. In the company KPI information 4 in the present embodiment, information such as target value and importance is associated with each goal such as cost reduction. The company KPI information 4 is input from the management devices 41 and 42 according to the operation of the management 5-3. It is preferable that the company KPI information 4 includes items corresponding to the company KPI (items) in the variable correspondence table 86. In addition, as described above, the company KPI information 4 is KPI information about the client company, and is preferably KPI information for achieving the management goals of the client company.

Lastly, FIG. 9 shows the maintenance work plan 6 created in the present embodiment. The maintenance work plan 6 in the present embodiment is created according to the process shown in the flowchart described below. The content of maintenance, the on-site workers, and the parts, which indicate the content of the plan, are associated with each plan (plan 1, plan 2, and the like) . The symbol “o” in the drawing indicates the content of maintenance to be performed, the on-site worker to perform a work, and the parts to be used. Here, the content of maintenance, the on-site worker, and the parts are items similar to the items in the variable correspondence table 86 or the work history information 2, but are not limited thereto. In addition, the number of persons working on site is also recorded in the on-site worker.

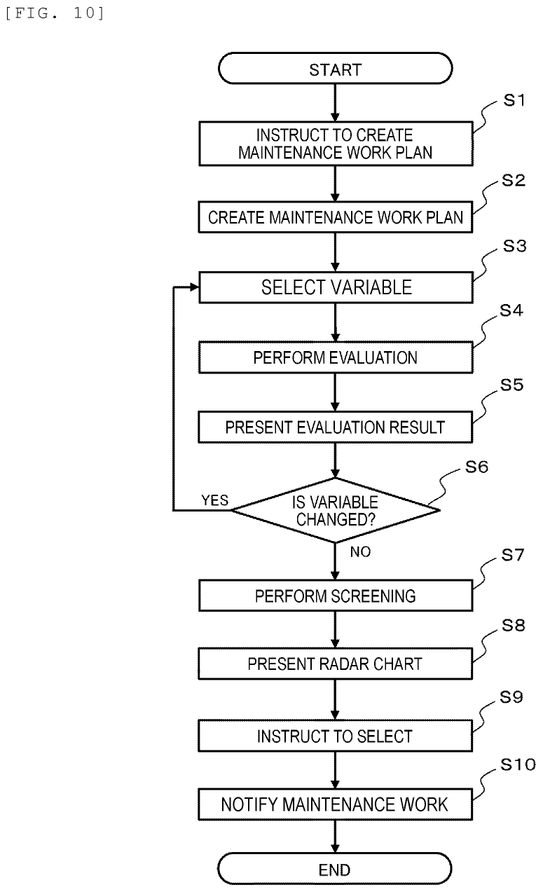

Next, details of the process in the present embodiment will be described. FIG. 10 is a flowchart showing details of a process of the device 12 for supporting maintenance work in the present embodiment. The details of FIG. 10 will be described below with the functional blocks (units) shown in FIG. 3 as the processing subject.

First, in step S1, the input unit 121 receives a maintenance work plan creation instruction from the instructor device 21. The maintenance work plan creation instruction includes information identifying the equipment in need of maintenance. In addition, as a prerequisite for step S1, a repair request is received. For example, the instructor device 21 preferably receives a request for creating the maintenance work plan from the worker terminal 51 or the worker tablet 52, and notifies the work instructor 5-1 of the need for maintenance by telephone or the like. In addition, instead of receiving the request for creating the maintenance work plan, the instructor device 21 may acquire the site information 3 from the integrated database 11 to determine the need for maintenance. It is desirable that the instructor device 21 displays an alert when the maintenance work plan creation instruction is required.

Next, in step S2, in response to the maintenance work plan creation instruction, the maintenance work plan creation unit 123 creates a plurality of the maintenance work plans 6 as shown in FIG. 9. For this purpose, the maintenance work plan creation unit 123 uses the function of the AI 1. For example, the repair recommendation technology disclosed in PTL 1 is used. In addition, it is desirable that the maintenance work plan creation unit 123 creates the maintenance work plan 6 using the information stored in the integrated database 11 and the parts inventory information in the parts inventory database 31.

Then, in the same step, the maintenance work plan creation unit 123 uses the output unit 122 to present the created maintenance work plan 6 to the instructor device 21. In addition, the maintenance work plan creation unit 123 stores the created maintenance work plan 6 in the integrated database 11.

Next, in step S3, the input unit 121 receives, from the instructor device 21, viewpoints to be considered in maintenance work in order to screen the maintenance work plan 6. These viewpoints are input to the instructor device 21 from the work instructor 5-1. It is desirable to select the variable from the variable “name” in the variable correspondence table 86. For this reason, it is desirable that the maintenance work plan creation unit 123 uses the output unit 122 to output variable candidates to the instructor device 21.

Next, in step S4, the evaluation unit 124 calculates an evaluation that reflects the received viewpoints, that is, the variables, for the maintenance work plan 6. Here, each variable used in calculating the evaluation and the variable correspondence table 86 will be described.

First, variables of the content of the maintenance in the variable correspondence table 86 will be described. The difficulty of maintenance is a digitization of how difficult the maintenance is. When the target work is difficult, such as when special qualifications are required for the maintenance work, the value of the difficulty of maintenance increases. Here, in order to specify the difficulty of maintenance, the content of necessary work such as insulation and replacement may be used. In addition, in the attribute column in the variable correspondence table 86 in FIG. 5, whether the corresponding variable is “numerical value” or “category” is recorded. Since the difficulty of maintenance is the digitized data, the “numerical value” is recorded.

Next, the equipment in need of maintenance is information for determining whether the equipment in need of maintenance is the equipment in charge of the assigned on-site worker. In addition, the required qualification is information for determining qualifications required for maintenance, and whether the on-site worker can be assigned. The required qualification includes an electrician's license, for example. These indicate that the attribute is a category, that is, a content thereof. In addition, a standard work time indicates the standard work time for each part in maintenance work.

Next, the variables of the on-site worker in the variable correspondence table 86 will be described. First, the equipment in charge is information for determining a type of equipment that the on-site worker can repair and whether the worker can be assigned to the maintenance. In addition, qualification held is information for determining a type of qualification held by the on-site worker and whether the worker can be assigned to the repair. Length of service indicates the number of years of service of the on-site worker, and a higher number of length of service indicates a higher ability of the worker. In addition, number of client services indicates the frequency that the on-site worker performs the client service which is the response to the client company, and a higher number of client services indicates a higher degree of experience of the on-site worker in client services.

In addition, work unit price indicates a work unit price of the on-site worker, and increases as the ability of the on-site worker increases. Estimated arrival time indicates the time required for the on-site worker to arrive at the site of the client, that is, at the maintenance site 50, and the smaller the estimated arrival time, the earlier the worker can arrive at the maintenance site 50. In addition, the estimated arrival time can be calculated from the current location information and the client's address (maintenance site). In the present embodiment, since maintenance is performed by the maintenance company, the expression “site of the client” is used, but when the client company performs maintenance, other expressions such as site of maintenance can be used. In addition, work skill indicates the number of times that the on-site worker performs a work for each part.

Next, variables of the parts in the variable correspondence table 86 will be described. First, replacement frequency indicates how frequently the part is replaced during maintenance. For example, parts that are handled frequently, such as parts that are replaced during regular inspections, have a high replacement frequency. In addition, part unit price indicates a part unit price of replacement parts.

Using parts with a high part unit price increases maintenance costs. However, when the cost of replacement parts is borne by the client company, there is no effect of the repair cost, so it is outside the above definition.

In addition, success rate after replacement indicates whether re-maintenances occurred when parts were replaced. The higher the success rate after replacement, the lower the re-maintenance rate. Further, part pick-up time, part delivery time, and pick-up location may be added to the part variables.

As shown in the drawing, the variable correspondence table 86 records whether the variables and company KPIs (items) are emphasized, used, or not used. This concludes the description of the variables and the variable correspondence table 86, and next, the calculation of the evaluation using these will be described. The evaluation unit 124 first calculates the variable values for the parts of the equipment in need of maintenance. For example, with respect to the difficulty of maintenance, the evaluation unit 124 uses the following (Equation 1) to calculate the difficulty of maintenance.

$$\begin{matrix}[ Equation 1 ] & \\ {MD}_{p} ( N ) = \frac{1}{{( min ( {NU}_{p} , {NW}_{p}^{N} ) )}^{1 / N}} & ( Equation 1 )\end{matrix}$$

MDₚ: Difficulty of maintenance of part P
NUₚ: Number of use of part P
NWₚ: Number of on-site workers having experience using part P
N: Parameter to determine increase/decrease rate of difficulty

Here, as one feature of the present embodiment, the number of on-site workers who have experience using a part P indicated by NW p is reflected in the calculation of the difficulty of maintenance. This is based on the assumption that the more on-site workers who have experience using the part P, the more standardized the repair using that part is, and the less difficult the repair will be. Therefore, by reflecting the number of on-site workers, it is possible to calculate the difficulty of maintenance more in line with the current situation.

It is to be noted that part P indicates a part used for the maintenance of the equipment in need of maintenance. In addition, when there are a plurality of corresponding parts, the evaluation unit 124 calculates the difficulty of maintenance for the equipment by summing the difficulties of maintenance of each of the parts. Then, the evaluation unit 124 calculates an evaluation for each variable. Here, as the variables for which the evaluation is calculated, the variables recorded in the variable correspondence table 86 and the variables used in the company KPIs calculated by (Equation 2) to (Equation 6) described below are used.

Next, the evaluation unit 124 calculates an evaluation for each company KPI in the variable correspondence table 86. The equations for calculating this evaluation are shown in (Equation 2) to (Equation 6).

$$\begin{matrix}[ Equation 2 ] & \\ & ( Equation 2 )\end{matrix}$$

$$Re - maintenance rate = MAX ( Success rate after replacement ) \times \frac{1}{( 1 + {e}^{- MIN ( \frac{MIN ( Work skill )}{5} , 100 )} )}$$

[Equation 3]

Driving time=MAX (Estimated arrival time) (Equation 3)

[Equation 4]

Cost=SUM (Part unit price)+SUM (Standard work time^{(Difficulty of maintenance)}×Work unit price) (Equation 4)

[Equation 5]

Client service=MAX (Number of client services) (Equation 5)

$$\begin{matrix}[ Equation 6 ] & \\ & ( Equation 6 )\end{matrix}$$

$$Education = \frac{1}{1 + {e}^{- \frac{MIN ( Work skill ) + 1}{5}}} - \frac{1}{1 + {e}^{- \frac{MIN ( Work skill )}{5}}}$$

It is to be noted that company KPIs are not limited to those in FIG. 5 or (Equation 2) to (Equation 6). In addition, regarding client service, when the client is responsible for the maintenance of their own equipment, this may be omitted, or the corresponding frequency in the operating section may be used.

Next, in step S5, the evaluation unit 124 uses the output unit 122 to present the evaluation result to the instructor device 21. In other words, the evaluation calculated in step S4 is output for each created maintenance work plan 6. Here, the evaluation unit 124 may output this result in the form of a list, or may output it in the form of a radar chart as in step S8, which will be described below.

Next, in step S6, it is determined whether the screening unit 125 receives a variable change instruction from the instructor device 21. As a result, if the variable change instruction is received (YES), the process returns to step S3 and the changed variable is received. If the variable change instruction is not received (NO), the process moves to step S7.

Next, in step S7, the screening unit 125 screens the maintenance work plan 6 using the evaluation result calculated in step S4. That is, in this step, the screening unit 125 selects the maintenance work plan 6 that satisfies a predetermined criterion from among the created maintenance work plans 6. For the criterion, it is desirable to use the highest evaluation (total). Further, for the evaluation, it is desirable to use a deviation value of the evaluation for each company KPI.

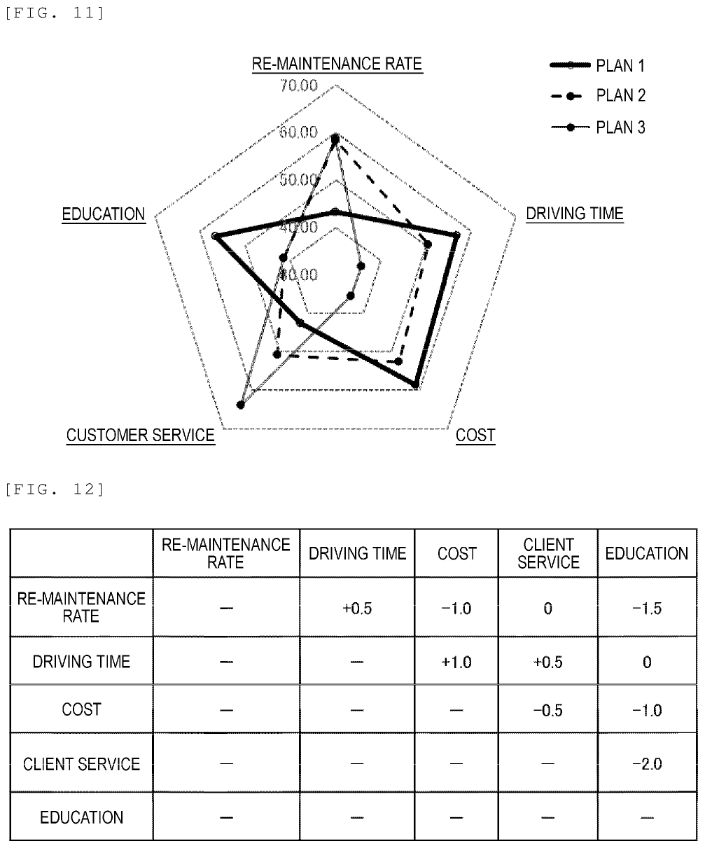

Next, in step S8, the screening unit 125 uses the output unit 122 to present the screened result to the instructor device 21. An example of its content is shown in FIG. 11. FIG. 11 shows that the evaluation result for the screened maintenance work plan 6 is displayed on the instructor device 21 as the radar chart.

Here, a plurality of company KPIs shown in the radar chart may have a certain degree of correlation with each other, and the degree of correlation varies greatly according to the variables that each company KPI has. For example, when a maintenance work plan is created to lower the “re-maintenance rate” in order to improve the company KPI “re-maintenance rate”, workers with higher “work skill” may result in a lower “re-maintenance rate”, but there also is a trade-off relationship, such as the “work unit price” tends to rise, and as a result, the “cost” tends to rise. For this reason, the process that takes this correlation into consideration will be described.

As a prerequisite for this process, the correlation information 7 indicating the degree of correlation of each of a plurality of company KPIs is registered in the integrated database 11 in advance. FIG. 12 shows the correlation information 7 used in the present embodiment. The correlation information 7 of the present embodiment indicates the extent to which an improvement in a predetermined company KPI of a plurality of company KPIs affects each of the other company KPIs. More specifically, the correlation information 7 records the degree of influence of each company KPI on the other company KPIs as numerical values. In the present embodiment, the deterioration is indicated by a “−” (minus) numerical value, and the improvement is indicated by a “+” (plus) numerical value. When there is no particular impact, it is indicated by “0”. In the “re-maintenance rate” in FIG. 12, “driving time” is improved, but “cost” and “education” are deteriorated. Here, since “education” has a larger negative range, it can be seen that the degree of deterioration is greater than that of “cost”. In addition, “client service” will not be affected in particular. It is to be noted that the correlation information 7 is information that indicates the relationship between a plurality of company KPIs, and may be from a perspective other than improvement and deterioration.

In the present embodiment, the correlation information 7 is used to present the company KPIs on a radar chart in the order according to the degree of correlation. For this reason, the screening unit 125 executes the following process in step S7.

First, the screening unit 125 extracts any company KPIs from the presented company KPIs. The extraction can be a company KPI designated from the instructor device 21. Furthermore, the screening unit 125 may extract the company KPI with the highest calculated evaluation. In the present embodiment, it is assumed that “re-maintenance rate” is extracted, for example.

Next, the screening unit 125 specifies the correlation information 7 of the other company KPIs with respect to the extracted company KPI, and sorts these in numerical descending or ascending order. In the present embodiment, it is sorted into “driving time”: +0.5, “client service”: 0, “cost”: −1.0, and “education”: −1.5.

Next, the screening unit 125 determines a display position of each company KPI on the radar chart according to the sorted order. In the present embodiment, with the “re-maintenance rate” at the apex, the items are arranged in the order of “driving time”, “client service”, “cost”, and “education” from the closest position to this apex. It is to be noted that this order may be the order in which deterioration is brought close to each other (correlation information is negative) . Thus, the order in the present embodiment indicates the display position.

In addition, for the sorting, the screening unit 125 may extract and sort the company KPI that satisfies a predetermined condition among the other company KPIs. For example, the screening unit 125 may extract the company KPI with the largest numerical value or the company KPI with deterioration or improvement. In this case, the screening unit 125 can place the extracted company KPI at a position farthest from or closest to the apex company KPI, and place the other company KPIs at empty positions.

As a result, on the radar chart, company KPIs with a low correlation between improvement and deterioration are displayed in the order in which they are adjacent to each other, and in other words, they are displayed in the order in which company KPIs with trade-off relationships are displayed away from each other. Therefore, by adopting the corresponding maintenance plan, it is possible to make it easier to determine what to emphasize and what to disregard. In addition, the process described above may be executed in step S5.

This evaluation result shows evaluation results centering on the company KPI for each of plans 1 to 3 of the maintenance work plans. Furthermore, in this radar chart, the numerical value of each axis is shown as a deviation value. This standardizes the evaluation of each axis. It is to be noted that this numerical value deviation may be executed in step S4, or may be executed when outputting in this step.

Next, in step S9, the input unit 121 receives a selection instruction for the presentation content in step S8 from the instructor device 21. At this time, the work instructor 5-1 may directly select the maintenance work plan 6 with reference to the KPI index such as cost as the optimization condition, or may designate the optimization condition. In the latter's case, the instructor device 21 selects the maintenance work plan with the largest evaluation value of the designated optimization condition and transmits the selected plan to the device 12 for supporting maintenance work.

Then, the screening unit 125 specifies the selected presentation content, that is, the maintenance work plan 6. That is, the screening unit 125 determines the specified maintenance work plan 6 as the optimum plan.

Lastly, in step S10, the screening unit 125 uses the output unit 122 to notify the relevant devices of the optimum plan. For example, the content is notified to the worker terminal 51 or the worker tablet 52 of the on-site worker of the optimum plan. Further, the screening unit 125 may output a request to arrange parts used in the optimum plan to the parts inventory management device 32.

According to the process in the present embodiment described above, it is possible to recommend maintenance work in accordance with the management goals of the client company that is the owner of the equipment, even when the maintenance work is performed by the maintenance company. This makes it possible to create a value for the maintenance work of the client company.

### Second Embodiment

In the first embodiment, recommendations for the maintenance work are made according to the management goals of the client company. In addition to the first embodiment, the present embodiment makes it easy to select a maintenance work plan that matches company KPIs that are emphasized by the client company which is the owner of the equipment.

In the first embodiment, a plurality of company KPIs are evaluated for each maintenance work plan. Here, for the client company, “which maintenance work plan to select” is equivalent to “which company KPI to emphasize and which company KPI to ignore”, and greatly influences the management policy of the company.

Here, for the client company, it is desirable to create a maintenance work plan that matches their own intentions at the concept level of “which maintenance work plan to select” and “which company KPI to emphasize and which company KPI to ignore”. Therefore, in the present embodiment, a plurality of registered company KPIs indicating the intentions of client companies registered in advance and company KPIs included in each maintenance work plan are respectively compared between the same company KPIs. When the difference is within a predetermined numerical value, the maintenance work plan is recommended as a maintenance work plan to be adopted.

For this reason, in the present embodiment, the evaluation unit 124 performs the following process. The evaluation unit 124 reads the registered company KPIs 8 from the integrated database 11. FIG. 13 is a view showing the registered company KPIs 8 used in the present embodiment. As shown in FIG. 13, the registered company KPIs 8 record the evaluation that indicates the degree of importance placed on each company KPI by the corresponding client company. The target value of the company KPI 4 may be used instead of the registered company KPI 8.

In addition, the evaluation unit 124 compares each of the read registered company KPIs 8 with the calculated evaluation, that is, with the evaluation of each company KPI included in the maintenance work plan 6, and calculates the difference. Then, the evaluation unit 124 extracts maintenance work plans in which each difference is within a predetermined specified value.

These processes will be executed as part of step S4 in the first embodiment. Alternatively, the processes may be executed for selecting a maintenance work plan that satisfies the predetermined criteria in step S7, or may be performed for the selected maintenance work plan. In this case, it is desirable that the corresponding processes are executed by the screening unit 125.

Through the processes described above, it is possible to specify a maintenance work plan that matches the intentions of the client company, and create a maintenance work plan accordingly.

Furthermore, in the present embodiment, in step S8, the results of these processes may be presented in a radar chart as in the first embodiment. Specifically, the screening unit 125 associates the read registered company KPIs 8 with the company KPIs of each maintenance work plan 6 and presents the result. This makes it possible to compare the differences between KPIs in terms of area, making it easier to visually understand the degree of matching.

Although this completes the contents of each embodiment of the invention, it should be noted that the invention is not limited to the embodiments described above, and it is needless to say that various other applications and modifications may be implemented without departing from the gist of the invention described in the claims.

For example, the configuration of the device 12 for supporting maintenance work according to each of the embodiments described above has been described in detail and specifically in order to describe the invention in an easy-to-understand manner, and is not necessarily limited to those having all the components described above. In addition, it is possible to add, delete, and replace other components for a part of the configuration of the present embodiment.

Each of the configurations, functions, processing units, and the like described above may be implemented by hardware by designing a part or all of those with, for example, an integrated circuit. For example, dedicated hardware such as Field Programmable Gate Array (FPGA), dedicated LSI, and accelerator in CPU may be used for the process of the device 12 for supporting maintenance work.

In addition, the components of each device such as the device 12 for supporting maintenance work in the embodiment described above may be implemented in any hardware as long as each hardware can transmit and receive information to and from each other via a network. Further, a process performed by a certain processing unit may be implemented by one piece of hardware, or may be implemented by distributed processing by a plurality of pieces of hardware.

### REFERENCE SIGNS LIST

1: AI
2: work history information
3: site information
4: company KPI information
5-1: work instructor
5-2: on-site worker
5-3: management
10: data center
11: integrated database
12: device for supporting maintenance work
20: maintenance base
21: instructor device
30: parts base
31: parts inventory database
32: parts inventory management device
40: management area
41, 42: management device
50: maintenance site
51: worker terminal
52: worker tablet

1. A device for supporting maintenance work that supports a maintenance work of equipment, the device comprising:
an integrated database that stores work history information relating to the maintenance work of the equipment and company KPI information including a company KPI which is an item emphasized by an owner of the equipment;
a maintenance work plan creation unit that creates a maintenance work plan showing a plan for the maintenance work of the equipment using the work history information; and
an evaluation unit that calculates, for the created maintenance work plan using the company KPI information, an evaluation according to a company KPI corresponding to a plurality of variables indicating maintenance work conditions for the equipment.

2. The device according to claim 1, wherein the evaluation unit calculates the evaluation using the variables including a content of maintenance, an on-site worker, and a part.

3. The device according to claim 2, wherein the evaluation unit calculates the evaluation using the content of maintenance including a difficulty of maintenance of the equipment reflecting the number of corresponding on-site workers.

4. The device according to claim 3, wherein the evaluation unit calculates the difficulty of maintenance by a following equation:
$$\begin{matrix}[ Equation 1 ] & \\ {MD}_{p} ( N ) = \frac{1}{{( min ( {NU}_{p} , {NW}_{p}^{N} ) )}^{1 / N}} & ( Equation 1 )\end{matrix}$$
MDₚ: Difficulty of maintenance of part P
NUₚ: Number of use of part P
NWₚ: Number of on-site workers having experience using part P
N: Parameter to determine increase/decrease rate of difficulty

5. The device according to claim 1, further comprising:
a screening unit that selects a maintenance work plan from among a plurality of maintenance work plans according to the evaluation, the plurality of maintenance work plans being created by the maintenance work plan creation unit.

6. The device according to claim 5, further comprising:
an output unit that outputs an evaluation for each of a plurality of company KPIs for the selected maintenance work plan as a radar chart in an order according to correlation information, the correlation information that indicates a degree of correlation of each of the plurality of company KPIs being stored in the integrated database.

7. The device according to claim 1, wherein
the integrated database stores, for each of the plurality of company KPIs, registered company KPI information indicating an evaluation which is a degree of importance given by an owner of the equipment, and
the evaluation unit compares the evaluation of each of the plurality of company KPIs of the plurality of maintenance work plans with the evaluation of the registered company KPI information, compares differences, and specifies the maintenance work plan with a difference within a predetermined specified value as a maintenance plan to be adopted.

8. A method for supporting maintenance work using the device for supporting maintenance work that supports the maintenance work of equipment, the method comprising:
storing, in an integrated database, work history information relating to the maintenance work of the equipment and company KPI information including a company KPI which is an item emphasized by an owner of the equipment;
creating, by a maintenance work plan creation unit, a maintenance work plan showing a plan for the maintenance work of the equipment, using the work history information; and
calculating, by an evaluation unit, an evaluation according to a company KPI corresponding to a plurality of variables indicating maintenance work conditions for the equipment, for the created maintenance work plan using the company KPI information.

9. The method according to claim 8, wherein the evaluation unit calculates the evaluation using the variables including a content of maintenance, an on-site worker, and a part.

10. The method according to claim 9, wherein the evaluation unit calculates the evaluation using the content of maintenance including a difficulty of maintenance of the equipment reflecting the number of corresponding on-site workers.

11. The method according to claim 10, wherein the evaluation unit calculates the difficulty of maintenance by a following equation:
$$\begin{matrix}[ Equation 2 ] & \\ & ( Equation 2 )\end{matrix}$$
$$Re - maintenance rate = MAX ( Success rate after replacement ) \times \frac{1}{( 1 + {e}^{- MIN ( \frac{MIN ( Work skill )}{5} , 100 )} )}$$

12. The method according to claim 8, further comprising:
selecting, by a screening unit, a maintenance work plan from among a plurality of maintenance work plans according to the evaluation, the plurality of maintenance work plans being created by the maintenance work plan creation unit.

13. The method according to claim 12, further comprising:
outputting, by an output unit, an evaluation for each of a plurality of company KPIs for the selected maintenance work plan as a radar chart in an order according to correlation information, the correlation information that indicates a degree of correlation of each of the plurality of company KPIs being stored in the integrated database.

14. The method according to claim 8, wherein
the integrated database stores, for each of the plurality of company KPIs, registered company KPI information indicating an evaluation which is a degree of importance given by an owner of the equipment, and
the evaluation unit compares the evaluation of each of the plurality of company KPIs of the plurality of maintenance work plans with the evaluation of the registered company KPI information, compares differences, and specifies the maintenance work plan with a difference within a predetermined specified value as a maintenance plan to be adopted.
